(19) United States
(12) Patent Application Publication
(10) Pub. No.: US 2004/0168916 A1
(43) Pub. Date: Sep. 2, 2004

(54) Miniature device for separating and isolation biological objects and uses thereof

(76) Inventors: Alexandra Fuchs, Saint-Egreve (FR); Patrice Caillat, Echirolles (FR); Daniel Dupret, Sinsans-Calvisson (FR); Fabrice Lefevre, Nimes (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/475,511

(22) PCT Filed: Apr. 26, 2002
(86) PCT No.: PCT/FR02/01458

(51) Int. Cl. G01N 27/453

(52) U.S. Cl. 204/451; 204/601

(57) ABSTRACT

The invention concerns a miniature device for separating and isolating biological objects, the use of said device for isolating, separating, culturing and/or analysing biological objects and a method for separating and isolating biological objects using said device.

The present Invention relates to a miniature device for separating and isolating biological objects, to a method for separating and isolating biological objects using this device, and to its applications.

Biology, and in particular genomics, is currently experiencing a revolution in the ways of generating and processing data for its analyses. While more and more genetic sequence data are available owing to major projects to sequence organisms, the players in biology, in the medical world and the pharmaceutical industry are seeking to integrate all these data in large-scale and multiparameter analyses.

The world of microtechnology, in particular that of microsystems, has the means to satisfy this demand owing to its expertise in miniaturization, surface functionalization, microfluidics and techniques of fabrication on a large scale and at low cost.

At present, the marriage of these two worlds has given rise to multiparameter analysis tools known by the name of DNA chips. These tools are dedicated to the analysis of biological macromolecules (proteins and principally DNA).

There is a significant amount of research around the world in widely varied fields which, via microtechnology, are integrating biological protocols with smaller and smaller dimensions.

For example, microtitration plates have moved on from a standard format of 96 wells to a format of 384 then 1536 wells, as progress has been made in robotics. The use of these increasingly miniaturized microtechnologies makes it possible to reduce the volumes of reagents that are used, and hence to reduce the costs of analysis.

In the particular case of DNA chips, the analysis principle consists in ordering nucleic probes in X-Y arrays with smaller and smaller pitches, of the order of 20 μm.

Likewise, the step of processing the biological samples is tending toward size reduction, with the increasingly common integration of polymerization chain reactions (PCR) in DNA chips or those with a cell lysis function.

It has been hence already proposed, in particular in U.S. Pat. No. 6,071,394, to separate and fix cells on electronic chips by dielectrophoresis, cells in suspension in a suitable buffer being separated as a function of their dielectric properties. However, this technique does not make it possible to separate and isolate single biological objects for individualized analyses.

A further consequence of the current trend toward reducing the volumes of reagents that are used is the use of analyte tests on biological reagents fixed on solid surfaces, so as to progressively abandon the use of tests in tubes with homogeneous solutions.

Various solutions have thus been proposed for fixing biological molecules of interest on various materials such as glass, plastic or metal. For example, three principal approaches are currently known for fixing nucleic probes on a substrate:

the use of a glass substrate covered with poly-L-lysine, which is a polymer having an affinity with nucleic probes (Schena M. et al., Science, 1995, 270 (5235) 467-470),

the use of glass covered with a functionalized silane, in which case the nucleic probe carries a complementary function so as to form a covalent bond with the silane (O'Donnell M. J. et al., Anal. Chem., 1997, 69, 2438-2443),

the use of metal electrodes, for example made of gold, making it possible to copolymerize a simple monomer and a monomer carrying the nucleic probe.

Likewise in the field of proteomics, the fixing of peptides by means of conductive polymers carrying pyrrole functions (polypyrroles) has been particularly reported (Livache T. et al., Biosensors & Bioelectronics, 1998, 13, 629-634).

It is also possible to fix living biological objects, such as bacteria or eukaryotic cells, on solid substrates by various techniques:

grafting of antibodies, which are specific to the cell to be fixed, onto a solid substrate; there are in fact antibodies against the microorganisms commonly used in molecular biology (bacteria, yeasts), such as the anti-E. coli 1434 antibodies marketed by the company Fitzgerald Industries International, Inc., as well as antibodies against surface receptors (CD receptors) of lymphoid higher eukaryotic cells,

grafting of peptides, which are specific to certain cell types, onto the support (Holland J. et al., Biomaterials, 1996, 17, 2147-2156)

nonspecific functionalization of the support by polymers that permit cell adhesion (Aframian D. J. et al., Tissue Eng., 2000, 6 (3), 209-216).

These techniques are advantageous insofar as they lead to the formation of specific bonds between the biological object to be fixed and the support, but they require numerous steps of preparation and isolation before these can finally be fixed individually on the support.

The Inventors have therefore set themselves the task of providing a novel miniature device for separating and isolating biological objects, making it possible to retain an array approach with a large number of points, in which each point contains one and only one type or category of biological object but in which the prior operations of preparation, separation or isolation can be avoided or reduced, hence significantly reducing the number of operations for manipulating and pipetting the biological object to be processed.

The present Invention therefore relates to a miniature device for separating and/or isolating biological objects, having at least one first electrode integrated with the device, consisting of a structure provided with an array of reaction microcuvettes, each microcuvette having a bottom consisting of a reception zone, characterized in that said bottom is devoid of holes and the maximum surface area of said bottom of each microcuvette is defined so as to isolate a single biological object, said structure being connected to a supply circuit in order to create a potential difference between said first electrode and at least one second electrode integrated with or external to the device.

By virtue of this device, it is henceforth possible to fix only a single biological object per microcuvette, given that the coupling surface of the biological object to be fixed totally covers the reception zone, each microcuvette therefore containing only a single type of selected and fixed biological object, which can subsequently be processed collectively.

According to the Invention, the coupling zone of the biological object to be fixed consequently has either a surface area substantially identical to the surface area of the reception zone or a surface area greater than the surface area of the reception zone.

According to the Invention, the maximum surface area of the bottom of each microcuvette is preferably less than or equal to two times the smallest surface area of the biological object to be isolated. In a preferred embodiment of the Invention, the surface area of said bottom is less than or equal to the smallest surface area of the biological object to be isolated.

More particularly, this surface area is generally between 1 μm² and 400 μm², in particular between 1 and 50 μm².

According to the Invention, the maximum surface area of the bottom of each microcuvette is preferably less than the smallest surface area of the biological object to be isolated.

According to the Invention, a biological object is characterised by its container and its content. The container corresponds to any element making it possible to compartmentalize the content. The container may, for example, be the wall of a bacterial cell, the envelope of a virus, the membrane of a cell, a lipid double layer, micelles, a phospholipid bilayer crossed by intrinsic proteins, etc. The content corresponds to the biological material isolated in a compartment constituted by the container. The content may, for example, correspond to nucleic acids, proteins, ribosomes, membrane vesicles or to a complex mixture thereof.

Examples of a biological object which may be mentioned are any cell, healthy or otherwise, whether prokaryotic or eukaryotic, viruses, liposomes, etc.

Examples of a cell which may be mentioned are bacteria, yeasts, fungi, microalgae, as well as cells of vegetable, animal and human origin.

Examples of a virus which may be mentioned are the HIV virus, bacteriophages, etc.

The device according to the Invention may advantageously be used in the field of cell analysis by fixing a single biological object of interest on the reception zone, which actually constitutes a trap zone, or by subsequently fixing one or more elements derived from the previously fixed biological object of interest, these derivatives including products coming from possible lysis of the biological objects, their localized PCR treatment, or any other biological, chemical or electrical treatment. DNA chips are spoken of when these derivatives correspond to nucleic acids, and protein chips are spoken of when these derivatives correspond to proteins.

The array of reaction microcuvettes may be surmounted at least partly by one or more layers of insulating materials and/or an attached grid of biocompatible plastic, so as to form an array of microreservoirs, each microreservoir containing at least one microcuvette. These microreservoirs may, for example, be produced by lithography of the layer of insulating material.

The insulating materials may, for example, be selected from insulating polymers such as polyimides and resins, such as for example SU-8 resins.

The size of the microreservoirs is defined so as to process the single isolated biological object in a minimum volume. These microreservoirs generally have a width and/or a length of between 5 and 500 μm, and preferably between 5 and 100 μm.

According to a particular embodiment of the Invention, the miniature device may include an alternation of conductive layers (electrodes) and layers of insulating materials.

According to one embodiment of the Invention, one face of the first electrode integrated with the device may constitute the bottom of the microcuvettes.

According to another embodiment of the Invention, the bottom of the microcuvettes of the device is constituted by a layer of glass, plastic or silicon.

When the device according to the Invention includes an integrated second electrode, the latter is deposited on a first layer of insulating material and lies in a plane separated from the bottom of the microcuvettes.

When the device according to the Invention includes an external second electrode, the latter may be secured to a cap or a lid, preferably consisting of one or more layers of insulating material.

Instead of forming an integral part of the device according to the Invention, one of the layers of insulating materials may consequently be in the form of a removable attached piece (mask, cap, lid) which at least partly covers said device and optionally contains at least one electrode.

The device according to the Invention may also have at least one third electrode integrated with the device, a second layer of insulating material being interposed between the second and third electrodes. In this case, and according to a variant of the Invention, the device may include a plurality of said second and/or third electrodes insulated from one another.

The device according to the Invention may also be equipped with an integrated circuit for multiplexing at least some of said electrodes.

The multiplex circuit integrated with this device may be used for different functions: fixing of various reagents within a same device, isolated heating of the reception zones, local pH measurement, reading of an electrical signal, etc.

In the devices according to the Invention, at least one edge of one of the second and/or third electrodes, and/or of one of the first and/or second layers of insulating materials, may constitute at least one part of an edge of a microreservoir.

According to the Invention, the first, second and third electrodes, as well as the external electrode, consist of at least one metal layer, for example of chromium, gold or platinum.

These metal layers generally have a thickness of between 0.1 and 10 μm.

According to one embodiment of the Invention, a reagent capable of fixing the biological object to be isolated is fixed on at least one part of a reception zone of the reaction microcuvettes.

The nature of the reagent used for fixing the biological objects may vary as a function of the nature of the objects to be fixed and the nature of the bottom of the microcuvettes.

Specifically, when the bottom of the microcuvettes consists of an electrode as described above, the reagent that is used is preferably selected from conductive copolymers, for example polypyrroles, on which are fixed proteins, peptides or any molecules specific to the type of biological object to be fixed such as, for example antibodies, receptors, glycoproteins, lectins, cell adhesion molecules (CAM), laminin, fibronectin, integrins, sugars, etc.

Conductive copolymers are, for example, described in International Application WO 94/22889.

Polypyrroles are particularly preferred according to the Invention.

The specific molecules fixed on the monomers of the conductive copolymer may, in particular, be selected from protein A, protein G, fibronectin and, more generally, from cell adhesion proteins and antibodies targeted against surface receptors.

The fixing of these molecules on the monomers of the conductive copolymer, and in particular on pyrrole monomers, may be carried out according to different techniques:

either the specific molecules are fixed directly on the monomers of a conductive polymer, in which case said monomers are carriers of —NHS or aldehyde functions capable of reacting with the primary amine functions of the molecule that is used,

or the specific molecules are fixed indirectly on the monomers of a conductive polymer that carries the biotin function, by means of a successive streptavidin-biotin-specific molecule chemical stack. In order to produce this chemical stack, the device according to the Invention is therefore processed collectively so as to copolymerize the monomers of the conductive polymer carrying the biotin function, then to process said device by streptavidin then with a specific molecule bound to biotin, in order to obtain pyrrole-biotin-streptavidin-biotin-specific molecule copolymers.

In a first embodiment, the reagent used for fixing the biological object may be specific to the latter, in order to permit a direct interaction: reagent of the microcuvette-biological object.

In a second embodiment, the reagent that is used is not specific to the biological object. The latter will therefore need to become functionalized.

To this end, the biological objects to be fixed may, for example, be functionalized beforehand with specific antibodies capable of reacting with the reagents that are used. In this case, the protein A or G fixed only on the trap zone by means of a conductive polymer will recognize the Fc fragment of the antibodies fixed beforehand on the objects to be immobilized.

Among the peptides which may be fixed on the monomers of the conductive polymer, particular mention may be made of binding peptides specific to the surface membrane receptors of the biological object to be fixed, for example peptides which contain the arginine-glycine-aspartate (RGD) sequence and have an affinity for integrins (cell adhesion protein on the surface of eukaryotic cells).

When the bottom of the microcuvettes consists of a layer of glass, plastic or silicon, the reagent that is used is preferably:

a polymer not specific to the type of object to be fixed, for example, poly-L-lysine or fibronectin; said polymer being deposited locally on the reception zones (lift-off technique: deposition of a photoimageable resin, localized exposure then deposition of the polymer on the resin, then deblocking of the resin),

a protein or peptide; in this case, the proteins and the peptides are fixed to said layer of glass, plastic or silicon which is covered with a layer of silane modified with —NHS or aldehyde functions on which said reagent is fixed; the proteins and the peptides that are used in this case being of the same nature as those described above.

According to a second embodiment of the Invention, the reception zone of the reaction microcuvettes does not include any reagent capable of fixing the biological object intended to be isolated.

In this case, the fixing of the biological object is directly carried out by means of an electric field.

This embodiment is particularly advantageous because it avoids prior functionalization of the devices according to the Invention with a reagent capable of fixing the biological object to be isolated. This embodiment is more particularly well-suited to isolating and fixing bacteria.

As described above, the device according to the Invention may contain a plurality of first and/or second and/or third electrodes. These electrodes may be either independent, microreservoir by microreservoir, in order to make it possible to read an electrical signal in response to a reaction that has taken place in the microcuvette, or connected together in order to allow identical treatment in all the microcuvettes, such as for example the application of an electric field for lysis of the biological objects or an electric field for copolymerization.

The various levels of electrodes may permit specific fixing of the biological objects then, once the objects have been fixed in the microcuvettes, lysis of these objects then, for example when biological cells are involved, fixing by electrical copolymerization of the nucleic probes coming from a nucleotide amplification carried out directly in each of the microreservoirs, so as to obtain microreservoirs carrying nucleic probes in a large quantity.

When the device according to the Invention is equipped with an integrated multiplex circuit, it is then possible to arrange for fixing of different reagents in the microcuvettes of a given device and processing of all the signals emitted by the electrodes of each microreservoir.

When it is equipped with an integrated multiplex circuit, the device according to the Invention may therefore include microcuvettes containing different reagents so as to make it possible to fix biological objects of different types on a single device.

The presence of electrodes associated with an integrated multiplex circuit also permits electrical detection at the level of a microcuvette or a microreservoir, this detection being for example associated with monitoring of the electrical behavior of a biological object or the release of molecules in response to a chemical or physical attack.

The miniature device according to the Invention may be equipped with a closing means, such as for example a cap or a transparent film, making it possible to close off all the microreservoirs individually or collectively.

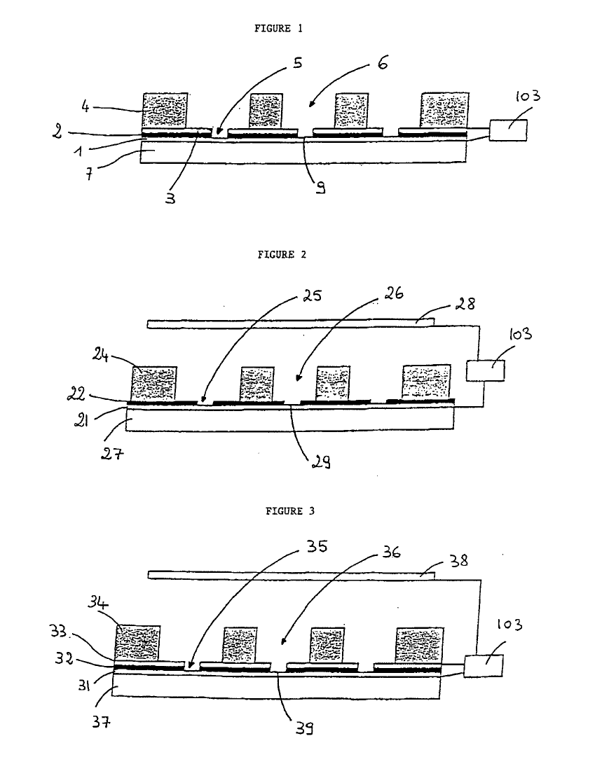

Other characteristics of the miniature device according to the Invention will become apparent in appended FIGS. 1 to 9, in which:

FIG. 1 represents a miniature device according to the Invention, equipped with a support 7 and an electrical supply circuit 103, in which the bottom of each microcuvette 5 consists of a first electrode 1, forming a reception zone 9 on which a reagent is optionally fixed, the first electrode 1 being surmounted by a first layer of insulating material 2, on which rests a second electrode 3 surmounted by a second layer of insulating material 4 forming microreservoirs 6,

FIG. 2 represents a miniature device according to the Invention, equipped with a support 27 and an electrical supply circuit 103, in which the bottom of each microcuvette 25 consists of a first electrode 21, forming a reception zone 29 on which a reagent is optionally fixed, the first electrode 21 being surmounted by a first layer of insulating material 22, on which rests a second layer of insulating material 24 forming microreservoirs 26, this device being equipped with an external electrode 28,

FIG. 3 represents a miniature device according to the Invention, equipped with a support 37 and an electrical supply circuit 103, in which the bottom of each microcuvette 35 consists of a first electrode 31, forming a reception zone 39 on which a reagent is optionally fixed, the first electrode 31 being surmounted by a first layer of insulating material 32, on which rests a second electrode 33 surmounted by a second layer of insulating material 34 forming microreservoirs 36, this device being equipped with an external electrode 38,

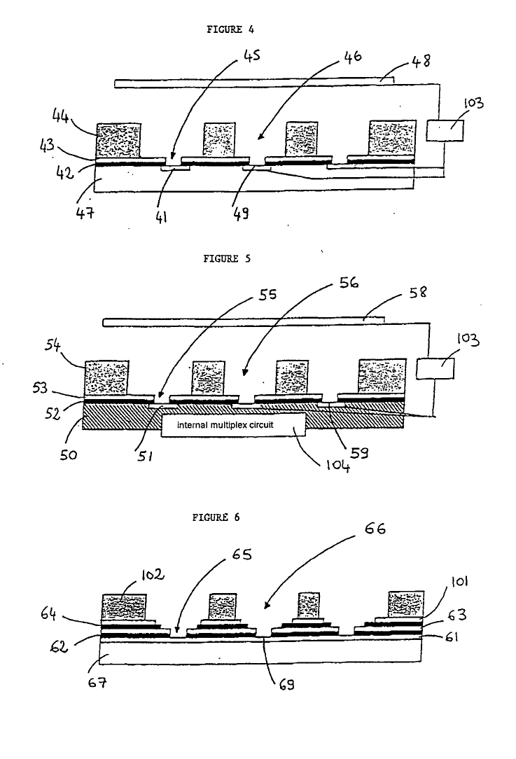

FIG. 4 represents a miniature device according to the Invention, equipped with a support 47 and an electrical supply circuit 103, containing a plurality of first electrodes 41 electrically insulated from one another and in which the bottom of each microcuvette 45 consists of a first electrode 41, forming a reception zone 49 on which a reagent is optionally fixed, the first electrodes 41 being partly surmounted by a first layer of insulating material 42, on which rests a second electrode 43 surmounted by a second layer of insulating material 44 forming microreservoirs 46, this device being equipped with an external electrode 48,

FIG. 5 represents a miniature device according to the Invention, equipped with a support 50 and an electrical supply circuit 103, containing a plurality of first electrodes 51 electrically insulated from one another and in which the bottom of each microcuvette 55 consists of a first electrode 51, forming a reception zone 59 on which a reagent is optionally fixed, the first electrodes 51 being partly surmounted by a first layer of insulating material 52, on which rests a second electrode 53 surmounted by a second layer of insulating material 54 forming microreservoirs 56, this device being equipped with an external electrode 58 and an integrated multiplex circuit 104,

FIG. 6 represents a miniature device according to the Invention, equipped with a support 67 in which the bottom of each microcuvette 65 consists of a first electrode 61, forming a reception zone 69 on which a reagent is optionally fixed, the first electrode 61 being surmounted by a first layer of insulating material 62, on which rests a second electrode 63 surmounted by a second layer of insulating material 64, itself surmounted by a third electrode 101 on which rests a third layer of insulating material 102 forming microreservoirs 66,

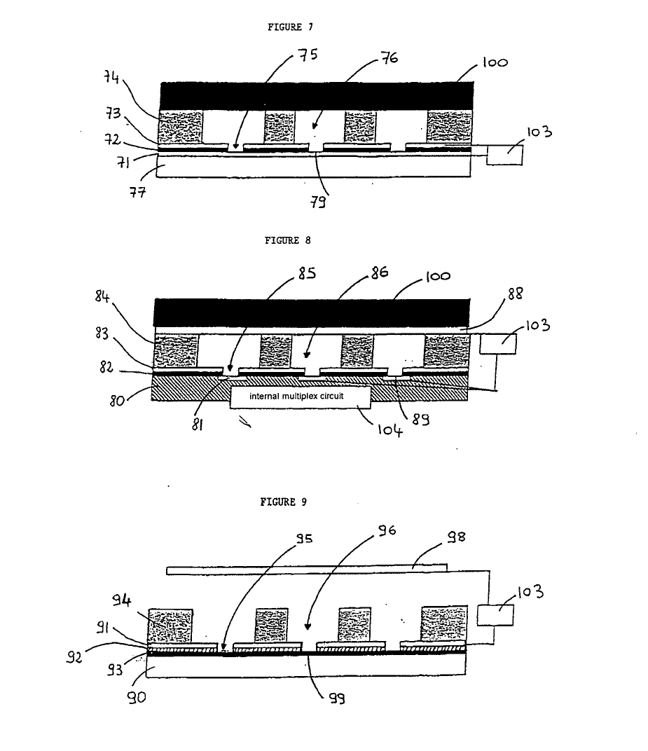

FIG. 7 represents a miniature device according to the Invention, identical to the one represented in FIG. 1 except that it furthermore has a removable closing means 100 making it possible to close each of the microreservoirs 76,

FIG. 8 represents a miniature device according to the Invention, identical to the one represented in FIG. 5 except that it furthermore has a removable closing means 100, making it possible to close each of the microreservoirs 86, in which an external electrode 88 is integrated,

FIG. 9 represents a miniature device according to the Invention, equipped with a support 97 and an electrical supply circuit 103, in which the bottom of each microcuvette 95 consists of a glass or silicon layer 93, forming a reception zone 99 on which a reagent is fixed, said glass or silicon layer 93 being surmounted by a first layer of insulating material 92, forming microreservoirs 96, on which rests a first electrode 91 itself surmounted by a second layer of insulating material 94, this device being equipped with an external electrode 98.

It is, of course, to be understood that the devices illustrated in these figures correspond to particular embodiments of the Invention, and do not in any way constitute a limitation thereof.

The methods for fabricating such devices are known and described, for example, in Patent Application FR-A-2 781 886.

The Invention also relates to the use of at least one miniature device according to the Invention for the isolation, separation, culture and/or analysis of biological objects.

By way of example, the miniature devices according to the Invention, and in particular the devices of the type represented by FIG. 2, may be used to fix one single biological object per microcuvette, such as for example a biological cell, the cells being subsequently cultivated directly on the device in order to amplify the cells by successive cell divisions. A device having a homogeneous population of cells in each microreservoir is thus obtained. The daughter cells produced by the cell divisions can subsequently be recovered, while the mother cells remained fixed on the bottom of the microcuvettes.

The devices according to the Invention therefore make it possible to recover just the daughter cells, which consequently correspond only to the cell lines capable of dividing. This use is beneficial insofar as it makes it possible to eliminate the dead cells of a bacterial culture, which have been transformed by plasmids and treated by antibiotics.

The devices according to the Invention may also be used as means for analyzing the content of a heterogeneous panel of cells, by immobilizing different cells in an ordered array at a ratio of one cell per microcuvette, then extracting the macromolecules intended to be analyzed. In this scope, it is possible

either to use devices provided with a plurality of independent first electrodes, such as the devices in FIGS. 4 and 5, in order to fix different reagents specific to each type of cells to be immobilized,

or to use a device such as that in FIG. 9, having microcuvettes whose bottom consists of a layer of glass carrying a chemical coupling function, or a device such as those represented by FIGS. 1 and 3, and to locally pipette specific reagents as a function of each type of cells to be immobilized.

The immobilization of the cells is subsequently carried out, for example, by immersion of the device in a heterogeneous culture of cells, or by successive immersions in various cultures of homogeneous cells, the presence of reagents specific to each type of cells making it possible to order the array of cells.

The second electrode present in all the devices used for immobilizing these cells may be either pre-functionalized collectively (for example by specific antibodies in order to extract one type of protein from each type of cell) or, more generally, they may be used for electrochemically fixing a product coming from the cell, for example following a PCR reaction.

The devices illustrated in FIGS. 4 and 5 may also be used to carry out high throughput screening (HTS) of chemical or biological reagents on the cells. In this case, the plurality of independent first electrodes permits individualized electrical measurement in response to the action of chemical or biological reagents on the cells in the microreservoirs.

These HCS screenings may be carried out on animal cells in culture and, in this case, the surface area of the bottom of the microcuvettes is equal to or less than the smallest section of the cells to be tested, i.e. about 100 μm² for conventional animal cells.

Furthermore, the devices according to the Invention may be used to carry out transient electroporation of the cells.

The Invention also relates to a method for separating and/or isolating biological objects, characterized in that it consists:

in a first step, in bringing at least one miniature device as defined above in contact with a homogenized solution of biological objects, in particular a culture solution of biological cells, in order to make it possible to fix said objects to the bottom of the microcuvettes on the reception zones, in a ratio of at most one biological object per microcuvette,

then in washing the unfixed biological objects in a second step, so as to obtain a miniature device on which the objects to be isolated are immobilized.

The biological objects thus isolated and fixed on the device may then be studied according to the techniques described above, for example by measuring the variation in their electrical properties under the effect of an active principle.

When the miniature device which is used according to this method has a multiplex circuit, it is then possible for individualized electrical measurements to be carried out in each microcuvette.

According to a first embodiment of the method according to the Invention, the fixing of the biological objects is carried out by means of an electric field. In this case, devices in which the first electrode integrated with the device constitutes the bottom of the microcuvettes are preferably used.

According to a second embodiment of the method according to the Invention, the fixing of the biological objects is carried out by means of a reagent fixed on at least one part of the bottom of the reaction microcuvettes. In this case, the bottom of the microcuvettes may as well be constituted by a first electrode, or by a layer of glass, plastic or silicon.

The method according to the Invention may optionally include a third step, during which the objects fixed to the bottom of the microcuvettes, especially when biological cells are involved, are lyzed so as to release the genetic material that they contain into the microreservoir corresponding to the microcuvette where they have been fixed.

The lysis of the fixed objects may be carried out on by electric shock, heat shock or sonication.

The genetic material thus released may then, in a fourth step, be amplified collectively using PCR by introducing the various reagents necessary for a PCR reaction into the microcuvettes, these reagents comprising in particular at least one primer functionalized by pyrrole groups. The amplified sequences thus obtained are then fixed collectively on an electrode by electropolymerization during a fifth step.

According to one particular embodiment of this method, the third and fourth steps may be carried out simultaneously.

According to yet another particular embodiment of the Invention, and when use is made of devices such as those illustrated by FIGS. 1 and 3 or a device such as the one represented by FIG. 9, it is possible to use these devices as a screening tool to find protein or nucleotide ligands of a given target.

In the case of trying to find a protein ligand, the initial cell culture is then a cell expression bank and the immobilization of the cells of the bank is carried out as described above.

The devices used according to this variant are functionalized beforehand by the target on an electrode. The target may be a molecule such as a peptide, a protein, a nucleotide sequence, a peptidoglycan, a sugar or any other chemical molecule. This target may also be functionalized by a pyrrole group, and thus to be fixed on an electrode by electropolymerization.

In each microcuvette, a recombinant protein will be expressed by the immobilized cell and released from the cell, either by secretion or by lysis of the cell. During this expression within each cell, it is possible to incorporate labeled protein precursors (such as for example S35-methionine) so that the protein expressed in this way is itself also labeled.

The proteins exhibiting an affinity with the target will be fixed specifically on the functionalized electrode with the target. If the proteins have been labeled during their expression, their detection may then be carried out. If not, the detection of the protein/ligand interaction needs to be carried out according to an additional step consisting, for example, in reacting a labeled anti-universal-epitope antibody and, in this case, it is necessary to use an expression bank that expresses all the recombinant proteins with this universal epitope.

The positive wells hence contain the potential protein ligands of the target. The level of affinity of this ligand may, for example, be estimated by means of successive, increasingly stringent washes or by competition with other known ligands.

Once the reaction as described above has taken place, it then remains to recover the clones corresponding to the positive wells.

If the immobilized cell is still viable, this recovery may be carried out by simply culturing the device and pipetting the daughter cells in the positive wells, as described above.

If the reaction as described above is deleterious to the cell division, care will have been taken beforehand to make a duplicate of the initial device containing the individualized cells of the bank (chip A).

One duplication method consists, for example, in culturing chip A then transferring the daughter cells orderly to an identical new device (chip B), the microreservoirs of chip A being optionally placed opposite the microreservoirs of chip B, while agitating.

Chip A then undergoes the processing as described above, in order to determine the wells containing the protein ligand of interest, while chip B makes it possible to recover the clones corresponding to these positive wells, for example by pipetting.

As an example of this particular embodiment of the Invention, the cell expression bank is an expression bank that secretes antibodies or antibody subdomains. The target fixed on the electrode is a protein, a peptide, a virus, an oligonucleotide, against which an antibody is to be found.

Further to the provisions indicated above, the Invention also comprises other provisions which will become apparent from the following description, which refers to examples of immobilizing bacteria on miniature devices according to the Invention, as well as to an example describing the protocol for preparing a DNA chip on a device according to the Invention.

### EXAMPLE 1

### Isolating and Fixing Bacteria on a Miniature Device by Means of Proteins A

A solution of protein A is prepared at 0.1 mg/ml in phosphate buffer (PBS).

A drop of this protein A solution is then deposited, using a pipette, on a miniature device according to the Invention and as described in appended FIG. 1, so that said drop covers all of the microcuvettes.

On this device, each microreservoir has a diameter of 230 μm and a depth of 40 μm; the surface area of the bottom of each microcuvette being 40 μm².

An electric field is subsequently applied for 10 seconds between the two electrodes of the chip: potential of +2.9 V on the electrode where the protein A is intended to be fixed, the other electrode being grounded.

When the fixing has been carried out, the device is then rinsed with a PBS solution.

A PBS solution containing a bacteria/antibodies complex is furthermore prepared.

To this end, a solution of E. coli DH5α in PBS (10⁹ bacteria/ml) is firstly prepared, as well as a solution of the corresponding anti-E. coli antibody (Dako) at 0.5 mg/ml.

These two solutions are then mixed (v/v) and left while agitating at room temperature for 1 hour and thirty minutes in order to form the bacteria/antibodies complex. The bacteria/antibodies complex is then concentrated by centrifuging, the excess antibodies being removed by extracting the supernatant. The operation is repeated three times, after returning the bacteria/antibodies complex to solution in PBS.

A drop of the solution containing the bacteria/antibodies complex is then deposited, using a pipette, on the miniature device functionalized by the Protein A, so that said drop covers all of the microcuvettes.

The miniature device is then left to incubate for 1 hour and 30 minutes at room temperature, in order to allow the bacteria/antibodies complex to become immobilized at the bottom of the microcuvettes.

At the end of the incubation, the device is then rinsed thoroughly with PBS in order to remove the bacteria/antibodies complexes that have not reacted with the protein A.

A device is obtained on which E. coli bacteria are immobilized in a ratio of one bacterium per microcuvette.

The miniature device according to the Invention, which has been prepared in this way, can then be used in various biological applications.

### EXAMPLE 2

### Isolating and Fixing Bacteria on a Miniature Device under the Action of an Electric Field

1) Fixing the Bacteria using an Electric Field

A suspension of E. coli DH5α bacteria in deionized water is prepared, in a ratio of 10⁹ bacteria/ml.

A miniature device identical to the one used in Example 1 above is then immersed in this bacterial suspension.

An electric field is subsequently applied for 10 seconds between the two electrodes of the chip: potential of +0.9 V on the electrode where the bacterium is intended to be fixed, the potential of the other electrode being set at −2 V.

When the fixing has been carried out, the device is then rinsed with water and dried using a nitrogen blow gun.

A device is obtained on which E. coli bacteria are immobilized in a ratio of one bacterium per microcuvette.

The miniature device according to the Invention, which has been prepared in this way, can then be used in various biological applications.

### EXAMPLE 3

### Preparating a DNA Chip by PCR from a Miniature Device According to the Invention

This example describes a general protocol to prepare a DNA chip on a miniature device according to the invention.

1) Depositing a Sense Primer on a Miniature Device According to the Invention

A 2.3⁻⁴ M solution of a sense primer modified in the 5′ position by a pyrrole group (0.77 μM) is prepared in lithium perchlorate at 2.3⁻² M.

This solution is deposited on the miniature device according to the Invention and as prepared above in Example 2.

An electric field is subsequently applied for 3 seconds between the two electrodes of the chip: potential of +2.9 V on the electrode where the primer is intended to be fixed, the other electrode being grounded.

The miniature device is then rinsed with water and dried using a nitrogen blow gun.

2) Lysis of the Bacteria

This step is carried out by heating the bacteria to a temperature of 94° C. for 2 minutes.

3) Carrying out the PCR

The PCR is carried out by using the following solution: Tris-HCl 1 mM, KCl 5 mM, MgCl₂ 2 mM, dNTP 0.8 mM; anti-sense primer labeled using biotin at the 5′ position: 0.1 μM, BSA 1 mg/ml, Taq DNA polymerase from ROCHE at 0.02 units/μl and sense primer at 0.01 μM.

The chip is then immersed in oil.

The PCR is carried out under the following conditions: 3 minutes at 94° C. then 30 cycles at 94° C. for 30 seconds, 60° C. for 30 seconds and 72° C. for 1 minute and 30 seconds; then 72° C. for 3 minutes and finally 25° C. for 30 seconds. The cycles are carried out in a Hybaid thermocycler.

The miniature device is subsequently rinsed with water after the end of the PCR cycles.

The amplified DNA is fluorescence-labeled using Streptavidin phycoerythrin.

The visualization of the fluorescence is subsequently carried out with the aid of a fluorescence microscope.

1. A miniature device for separating and/or isolating biological objects, having at least one first electrode integrated with the device, consisting of a structure provided with an array of reaction microcuvettes, each microcuvette having a bottom consisting of a reception zone, characterized in that said bottom is devoid of holes and the maximum surface area of said bottom of each microcuvette is defined so as to isolate a single biological object, said structure being connected to a supply circuit in order to create a potential difference between said first electrode and at least one second electrode integrated with or external to the device.

2. The device as claimed in claim 1, characterized in that the maximum surface area of the bottom of each microcuvette is preferably less than or equal to two times the smallest surface area of the biological object to be isolated.

3. The device as claimed in claim 2, characterized in that the surface area of said bottom is less than or equal to the smallest surface area of the biological object to be isolated.

4. The device as claimed in any one of claims 1 to 3, characterized in that the maximum surface area of the bottom of each microcuvette is between 1 μm² and 400 μM².

5. The device as claimed in claim 4, characterized in that the maximum surface area of the bottom of each microcuvette is between 1 and 50 μm².

6. The device as claimed in any one of the preceding claims, characterized in that the array of reaction microcuvettes is surmounted at least partly by one or more layers of insulating materials and/or an attached grid of biocompatible plastic, so as to form an array of microreservoirs.

7. The device as claimed in any one of the preceding claims, characterized in that one face of the first electrode integrated with the device constitutes the bottom of the microcuvettes.

8. The device as claimed in any one of claims 1 to 6, characterized in that the bottom of the microcuvettes is constituted by a layer of glass, plastic or silicon.

9. The device as claimed in any one of claims 6 to 8, characterized in that the insulating materials are selected from polyimides and resins.

10. The device as claimed in any one of claims 6 to 9, characterized in that the microreservoirs have a width and/or a length of between 5 and 500 μm.

11. The device as claimed in any one of the preceding claims, characterized in that it includes a plurality of said first electrodes electrically insulated from one another.

12. The device as claimed in any one of the preceding claims, characterized in that the second electrode is integrated with the device, and in that said electrode is deposited on a first layer of insulating material and lies in a plane separated from the bottom of said microcuvettes.

13. The device as claimed in any one of the preceding claims, characterized in that it has at least one third electrode integrated with the device, a second layer of insulating material being interposed between the second and third electrodes.

14. The device as claimed in claim 13, characterized in that it includes a plurality of said second and/or third electrodes insulated from one another.

15. The device as claimed in any one of claims 1 to 11, characterized in that the second electrode is external and in that it is secured to a cap or a lid.

16. The device as claimed in any one of the preceding claims, characterized in that it is equipped with an integrated circuit for multiplexing at least some of said electrodes.

17. The device as claimed in any one of the preceding claims, characterized in that a reagent capable of fixing the biological object to be isolated is fixed on at least one part of a reception zone of the reaction microcuvettes.

18. The device as claimed in claim 17 in combination with claim 7, characterized in that said reagent is selected from the conductive copolymers on which are fixed proteins, peptides or any molecules specific to the type of cell to be fixed.

19. The device as claimed in claim 18, characterized in that the conductive copolymers are selected from polypyrroles.

20. The device as claimed in claim 18 or 19, characterized in that the reagent is a pyrrole-biotin-streptavidin-biotin-specific molecule copolymer.

21. The device as claimed in claim 17, taken in combination with claim 8 characterized in that said reagent is selected from polymers not specific to the type of cell to be fixed.

22. The device as claimed in claim 21, characterized in that said polymers are poly-L-lysine.

23. The device as claimed in claim 17 taken in combination with claim 8, characterized in that the reagent is a protein or peptide, and in that said layer of glass, plastic or silicon is covered with a layer of silane modified with —NHS or aldehyde functions on which said reagent is fixed.

24. The device as claimed in claim 17, characterized in that it includes microcuvettes containing different reagents.

25. The device as claimed in any one of the preceding claims, characterized in that it is equipped with a closing means.

26. The use of at least one miniature device as claimed in any one of the preceding claims, for the isolation, separation, culture and/or analysis of biological objects.

27. A method for separating and/or isolating biological objects, characterized in that it consists:
in a first step, in bringing at least one miniature device as defined in any one of claims 1 to 25 in contact with a homogenized solution of biological objects, in particular a culture solution of biological cells, in order to make it possible to fix said objects to the bottom of the microcuvettes on the reception zones, in a ratio of at most one biological object per microcuvette,
then in washing the unfixed biological objects in a second step, so as to obtain a miniature device on which the objects to be isolated are immobilized.

28. The method as claimed in claim 27, characterized in that the fixing of the biological objects is carried out by means of an electric field.

29. The method as claimed in claim 27, characterized in that the fixing of the biological objects is carried out by means of a reagent fixed on at least one part of the bottom of the reaction microcuvettes.

30. The method as claimed in any one of claims 27 to 29, characterized in that a device having microreservoirs is used, and in that it includes a third step, during which the objects fixed to the bottom of the microcuvettes are lyzed so as to release the genetic material that they contain into the microreservoir corresponding to the microcuvette where they have been fixed.

31. The method as claimed in claim 30, characterized in that it includes a fourth step, during which the released genetic material is amplified by PCR.

32. The method as claimed in claim 31, characterized in that the third and fourth steps are carried out simultaneously.

33. The method as claimed in claim 31 or 32, characterized in that the amplified sequences are fixed on an electrode by electropolymerization during a fifth step.

34. The method as claimed in any one of claims 27 to 33, characterized in that the device which is used has a multiplex circuit, and in that individualized electrical measurements are carried out in each microcuvette.

35. The method as claimed in any one of claims 27 to 34, characterized in that the device which is used has a multiplex circuit, and in that the biological objects to be isolated come from a heterogeneous panel of cells.

36. The use of at least one device as claimed in any one of claims 1 to 25, as a screening tool to find protein or nucleotide ligands of a given target.
